(19) United States
(12) Patent Application Publication
(10) Pub. No.: US 2002/0128983 A1
(43) Pub. Date: Sep. 12, 2002

(54) Method and device for returning of change in an electronic payment system

(76) Inventors: Konrad Wrona, Aachen (DE); Robert Daniel Tracz, Karczmiska (PL)

Correspondence Address: Spencer C. Patterson, Esq., Jenkens and Gilchrist, P.C., 3200 Fountain Place, 1445 Ross Ave., Dallas, TX, 75202, US

(21) Appl. No.: 10/035,526

(22) Filed: Nov. 9, 2001

(30) Foreign Application Priority Data
Nov. 10, 2000 (EP) 00124631.3

(51) Int. Cl. G06F 17/60

(52) U.S. Cl. 705/71

(57) ABSTRACT

In a method of returning change to a payer in an electronic payment system, a payer determines a change return value, generates and blinds a change return certificate, generates a first signature by signing the blinded change return certificate, and sends a message comprising the first signature to a payee. The payee forwards the message to a payment provider. The payment provider verifies the first signature and the change return value indicated by the message, generates a blinded second signature by signing the blinded change return certificate, and forwards the blinded second signature to the payer. The payer unblinds and verifies the blinded second signature, and forms a second payment certificate. A method of performing tasks of a payer, a method of performing tasks of a payment provider in a change return transaction, and computer programs and devices therefor are also disclosed.

### BACKGROUND OF THE INVENTION

1. Technical Field

The invention relates to a method and computer program for returning change in an electronic payment system to a device of a payer and to a device of a payment provider for use in a change returning electronic payment transaction.

2. History of Related Art

The volume of e-Commerce transactions has risen quickly. Electronic payment systems are currently being developed for customers using both fixed and mobile terminals. The acceptance of an electronic payment system by a customer depends on the protection of the anonymity of the customer as well as on the untraceability and unlinkability of the payment transactions.

There are several anonymous untraceable token-based electronic payment systems. An overview can be found in “Chablis—Market Analysis of Digital Payment Systems”, R.Weber, Technical Report, Institut für Informatik der Technischen Universität München, TUM-19819.

The value of a token (i.e., a payment certificate) can be spent in two ways. It can be spent as an electronic coin, wherein the certificate is treated as an indivisible monetary unit like a coin. This is the way macropayments are paid. It can alternatively be spent as a certificate for a micropayment series. A payer generates in the case of a micropayment series a chain of one-way function values and signs an initial value w₀ with the private key corresponding to the payment certificate. When the signature is verified and the certificate is checked against double spending, the payer can start releasing subsequent w₁ as micropayments. These micropayments can preferably be performed off-line. Thus even extremely small values can be paid effectively. The payment provider signs the payment certificate with a key that is unique for the value, issuer, and validity period of the signed payment certificate. Thus, the signature implicitly determines these parameters. Also, this lets the payment provider be sure of these values of the payment certificate even if the signature is blind.

A system supporting both macropayment and micropayment is the Conditional Access for Europe (CAFE) system, which is described in Esprit 7023 CAFE Document PTS9364 “Technical Specifications”, April, 1996. In this system, the payer's terminal consists of a tamper resistant smart card (cc wallet) or contains a tamper resistant observer (F wallet). A money counter, so-called currency table, is held at the payer's side. During a macropayment transaction, a payment check is filled with the exact amount of the transaction and the currency table is updated. During a micropayment series (so called phone-tics), the currency table is updated after a whole series is paid. All other mechanisms remain the same as in the macropayment. Thus, there is no need for any change return. The payment provider has to trust the currency table, and a payment cannot succeed without an appropriate update of the currency table. This, however, requires a tamper resistant device, which narrows potential applications of the system.

Another system is called Ecash, which is an online, anonymous, and untraceable payment system developed by D. Chaum. Ecash does not support a return of change. Therefore, the customer is required to pay the exact price during an electronic payment transaction.

So far, many electronic cash payment systems have been proposed; however, none of them provides a solution to the problem of anonymous, untraceable, and robust returning of change to the payer. It is a known concept to get change directly from the payee, i.e., a whole payment transaction is performed as a dual-payment between a merchant and a client. This requires that the client deposit the change at the bank after receiving the change from the payee, or requires a system that supports an off-line verification with a tamper-proof observation unit. If the deposit activity is combined with the payment transaction, the client's anonymity can be lost. If the change is deposited after the payment itself, an additional online connection to the bank is required to be set up by the client. Furthermore, a dishonest merchant could cause a client to accept worthless change, if the payment verification is processed before the change verification and the change deposit.

Another known solution to overcome the problem of returning change is to request, prior to the payment, from the bank an electronic coin with the exact required payment value or a number of coins adding up to the exact required payment value. In these cases, the bank can perform timing analysis of the transactions in order to identify and to trace the clients by correlating the client's withdrawals and the merchant's deposits of the same values. Since each client has to authenticate himself prior to a withdrawal, the bank can associate the withdrawal value with the client's identity, even if the bank cannot see the serial numbers of the issued coins in the case they are blinded. Furthermore, the coins with the exact required payment value must be withdrawn from the bank before the payment is performed. This requires an online connection from the client to the bank in addition to the connection between the client and the merchant. Such an online connection requires a certain time and causes additional cost.

In the alternative, the bank itself could generate the change. This does not guarantee the client's untraceability. Since the bank would know the serial numbers of the electronic coins, it could easily correlate a next payment to the same payer.

### SUMMARY OF THE INVENTION

It is therefore an object of the present invention to provide an improved method, a device and a computer program for returning a change in an electronic payment system.

In a method of returning change to a payer in an electronic payment system, the payer pays a due amount to a payee by means of a first payment certificate having a value of a first amount higher than the due amount, a payment provider receives the first payment certificate, verifies the first payment certificate, and credits the due amount to the payee. The payer determines at least one change return value such that the sum of the determined change return values is equal to the difference of the first amount and the due amount. The payer generates at least one change return certificate according to the at least one change return value, blinds the change return certificate, and generates a first signature by signing the blinded change return certificate. The payer sends a message comprising the first signature to the payee, who forwards the message to the payment provider.

The payment provider verifies the first signature, and the change return value indicated by the message, and generates a blinded second signature by signing the blinded change return certificate, if the verification of the first signature and of the change return value is successful. Then the payment provider forwards the blinded second signature to the payer.

The payer unblinds the blinded second signature, verifies the second signature, and forms at least one second payment certificate by linking the change return certificate and the unblinded second signature.

Embodiments of the invention provide a flexible, convenient, and robust payment functionality that will suit also the needs of future customers, as it is applicable for present and future mobile and fixed communication networks. The change returning method is optimized for mobile networks providing packet services as well as for fixed networks.

Embodiments of the invention ensure the anonymity of the payer and both the untraceability and unlinkability of his transactions towards the payment provider. This is achieved by the efficient use of blind signatures on the electronic certificates issued by the payment provider. The signatures received as a change are anonymous and neither of the parties involved in the transaction can recover the identity of the payer nor benefit from interfering with protocol messages. For the payment provider, the issuance of the electronic money will be impossible to link with the spending.

The following steps are performed by the payer during a change returning transaction in an electronic payment system, wherein the payer pays a due amount by means of a first payment certificate having a value of a first amount higher than the due amount: The payer determines at least one change return value such that the sum of the determined change return values is equal to the difference of the first amount and the due amount. He generates at least one change return certificate according to the at least one change return value, and blinds the change return certificate. Then he generates a first signature by signing the blinded change return certificate, and sends a message comprising the first signature to the payee. After that, the payer receives a blinded second signature comprising a signed blinded change return certificate, unblinds the blinded second signature, and verifies the second signature. Furthermore, the payer forms at least one second payment certificate by linking the change return certificate and the unblinded second signature.

The following steps are performed by a payment provider during a change returning transaction in an electronic payment system, wherein a payment provider receives a first payment certificate having a value of a first amount higher than the due amount, verifies the first payment certificate and credits the due amount to a payee: The payment provider receives a message comprising a first signature of a blinded change return certificate. He verifies the first signature as well as a change return value indicated by the message. If the verification of the first signature and of the change return value is successful, he generates a blinded second signature by signing the blinded change return certificate, and sends the second signature to a payee.

The proposed change return transaction allows for an easy implementation on appropriate devices of the payer and the payment provider, i.e., an easy implementation in a payment device like a mobile phone or in a bank device. The tasks of the payer and the payment provider are well defined, therefore an effective interworking is guaranteed. Furthermore, the amount of interactions between the parties is reduced to a minimum in order to save communications costs.

An article of manufacture for returning change to a payer in an electronic payment system, wherein a due amount is paid by a payer to a payee via a first payment certificate having a value of a first amount higher than a due amount includes at least one computer readable medium and processor instructions contained on the at least one computer readable medium. The processor instructions are configured to be readable from the at least one computer readable medium by at least one processor and thereby cause the at least one processor to operate as to receive the first payment certificate, verify the first payment certificate, and credit the due amount to the payee. The payer determines at least one change return value such that the sum of the determined at least one change return value is equal to a difference between the first amount and the due amount. The payer also generates at least one change return certificate according to the at least one change return value. The payer blinds the change return certificate and generates a first signature by signing the blinded change return certificate. The payer sends a message comprising the first signature to the payee and forwards the message to the payment provider. The processor instructions are further configured to be readable from the at least one computer readable medium by the at least one processor and thereby cause the at least one processor to operate as to verify the first signature, verify a change return value indicated by the message, generate a blinded second signature by signing the blinded change return certificate if the verification of the first signature and of the change return value is successful, and forward the blinded second signature to the payer. The payer unblinds the blinded second signature, verifies the second signature, and forms at least one second payment certificate by linking the change return certificate and the unblinded second signature.

A payment device includes means for determining at least one change return value such that the sum of the determined at least one change return value is equal to a difference of a first amount and a due amount, means for generating at least one change return certificate according to the at least one change return value, and means for blinding the change return certificate. The payment device also includes means for generating a first signature by signing the blinded change return certificate, means for sending a message comprising the first signature to a payee, means for unblinding a blinded second signature comprising a signed blinded change return certificate, means for verifying the second signature, and means for forming at least one second payment certificate by linking the change return certificate and the unblinded second signature.

A bank device adapted to perform tasks of a payment provider in a change returning transaction in an electronic payment system includes means for receiving a message comprising a first signature of a blinded change return certificate, means for verifying the first signature, means for verifying a change return value indicated by the message, means for generating a blinded second signature by signing the blinded change return certificate if the verification of the first signature and of the change return value is successful, and means for sending the second signature to the payee.

Computer programs in accordance with teachings of the invention can in general perform any task of the methods disclosed herein.

Furthermore, the invention relates to a payment device adapted to perform tasks of a payer in a change returning transaction in an electronic payment system, wherein the payer pays a due amount by means of a first payment certificate having a value of a first amount higher than the due amount. At least one change return value is determined such that the sum of the determined change return values is equal to a difference of the first amount and the due amount. At least one change return certificate is generated according to the at least one change return value. The change return certificate is blinded. A first signature is generated by signing the blinded change return certificate. A message comprising the first signature is sent to a payee. A blinded second signature comprising a signed blinded change return certificate is received. The blinded second signature is unblinded. The second signature is verified. At least one second payment certificate is formed by linking the change return certificate and the unblinded second signature. Advantageously, the device can also be adapted to perform any step of the method relating to the payer.

Furthermore, the invention relates to a bank device, adapted to perform tasks of a payment provider in a change returning transaction in an electronic payment system, wherein a payment provider receives a first payment certificate having a value of a first amount higher than the due amount and verifies the first payment certificate and credits the due amount to a payee. A message comprising a first signature of a blinded change return certificate is received. The first signature is verified. A change return value indicated by the message is verified. A blinded second signature is generated by signing the blinded change return certificate if the verification of the first signature and of the change return value is successful. The second signature is sent to the payee. Advantageously, the device can also be adapted to perform any step of the method, as long as these steps relate to the payment provider.

Appropriate devices for an implementation of the methods or, respectively, of the computer program are a payment device, for example, a mobile phone or an electronic wallet, for the payer's tasks, and a bank device for the payment provider's tasks. The signature schemes can be chosen in a way, that the payer performs always the computationally cheapest operation. However the optimization is not limited to the payment device only. For all involved parties of the change return transaction the computational costs are low. The invention provides good scalability and low installation costs.

Preferred embodiments of the present invention are described in the dependent claims.

According to one embodiment of the invention, a second asymmetric key pair comprising a second public key and a second private key is assigned by the payment provider to a change return value. The change return certificate is blinded by the payer by means of a blinding factor, which is encrypted by means of the second public key. The blinded second signature is generated by the payment provider by signing the blinded change return certificate by means of the second secret key. The unblinding of the blinded second signature by the payer comprises a division of the blinded second signature by the blinding factor. The verification of the second signature by the payer comprises a decryption of the unblinded second signature and a test, whether the decrypted unblinded second signature corresponds to a generated change return certificate. Therefore, the anonymity of the payer is ensured in an effective manner, while at the same time the effort for the second signature is low.

According to a further embodiment of the invention, the payment provider sends the second public key to the payee, and the payee forwards the second public key to the payer. This ensures, that the payee can use a second public key, which is up-to-date.

According to another embodiment of the invention, a second asymmetric key pair comprising a second public key and a second private key is assigned by the payment provider to the change return value. The change return certificate is blinded by the payer by means of a blinding factor, which is encrypted by means of the second public key. The blinded second signature is generated by the payment provider by signing the blinded change return certificate by means of the second secret key. Therefore, the anonymity of the payer is ensured in an effective manner, while at the same time the effort for the second signature is low.

According to another embodiment of the invention, the message comprising the first signature includes the first payment certificate in order to perform the crediting of the first amount. Therefore, just one online connection to the payee and/or to the payment provider is needed, which lowers the communication costs.

According to another embodiment of the invention, a first asymmetric key pair comprising a first public key and a first private key is assigned to the first payment certificate. The first payment certificate comprises the first public key, and the first signature is generated by the payer by means of the first private key. The verification of the first signature is performed by the payment provider by means of the first public key. This provides the change return certificate with a secure reference to the first payment certificate.

According to another embodiment of the invention, the first signature indicates the value of the first amount of the first payment certificate, and the payment provider verifies the value of the first amount of the first payment certificate. The implicit indication of the value of the first payment certificate supports the verification of the value in an easy manner.

According to another embodiment of the invention, the payment provider stores at least one from a group comprising the first signature and the message comprising the first signature. This allows for the payment provider an easy re-issuing of the response to the message comprising the first signature, i.e., of the second signature, in the case that a payee claims, that an already issued second signature has been lost.

According to another embodiment of the invention, a first asymmetric key pair comprising a first public key and a first private key is assigned to the first payment certificate. The first payment certificate comprises the first public key, the first signature is generated by means of the first private key. This provides the change return certificate with a secure reference to the first payment certificate.

According to another embodiment of the invention, a second asymmetric key pair comprising a second public key and a second private key is assigned to a change return value, the change return certificate is blinded by means of a blinding factor, which is encrypted by means of the second public key, the unblinding of the blinded second signature comprises a division of the second signature by the blinding factor, and the verification of the second signature comprises the decryption of the unblinded second signature and a test, whether the decrypted unblinded second signature is equal to a generated change return certificate. Therefore, the anonymity of the payer is ensured in an effective manner, while at the same time the effort for the second signature is low.

According to another embodiment of the invention, the first signature indicates the vaiue of the first amount of the first payment certificate. The implicit indication of the value of the first payment certificate supports the verification of the value in an easy manner.

According to another embodiment of the invention, the second key is received. This ensures that the payee can use a second public key, which is up-to-date.

According to another embodiment of the invention, the second payment certificate is sent to a third party for storing as a backup. This prevents a loss of the payment certificate, in case the payment device is lost or stolen or has a defect.

According to another embodiment of the invention, the first signature is generated by signing the blinded change return certificate and a change return value linked to the blinded change return certificate. This allows for an easy verification of the change return value due to a low necessary computational effort.

According to another embodiment of the invention, the message, which comprises the first signature and is sent to the payee, comprises at least one from a group comprising the blinded change return certificate and the change return value corresponding to the blinded change return certificate. This allows for easy verification of the change return value due to a low necessary computational effort.

According to another embodiment of the invention, the first payment certificate is a macropayment certificate. Macropayment transactions represent an easy and effective way of electronic on-line payment transactions.

According to another embodiment of the invention, the first payment certificate is a micropayment certificate. Micropayment transactions represent an easy and effective way of electronic off-line payment transactions.

According to another embodiment of the invention, the blinding of the change return certificate comprises the steps of building a digest of the change return certificate and blinding the digest. This increases the security of the change return transaction.

According to another embodiment of the invention, the message comprising the first signature includes the first payment certificate in order to perform the payment of the first amount. Therefore, just one online connection to the payee is needed, which lowers the communication costs.

According to another embodiment of the invention, the computer program is stored on a computer-readable medium. Therefore, the computer program can be transferred easily between payment devices, bank devices, or in general, between computers.

### BRIEF DESCRIPTION OF THE DRAWINGS

FIG. 1 shows a simplified payment model;

FIGS. 2a, 2b, and 2c show a method of returning change to a payer in an electronic payment system;

FIG. 3 illustrates an example of a change return certificate;

FIG. 4 shows a payment device; and

FIG. 5 shows a bank device.

### DETAILED DESCRIPTION OF EXEMPLARY EMBODIMENTS OF THE INVENTION

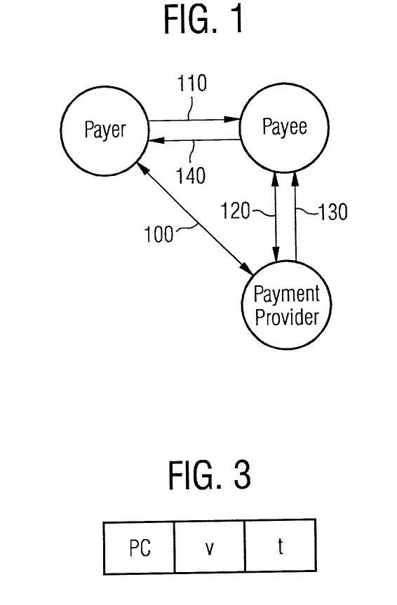

FIG. 1 shows a simplified payment model for electronic payment transactions. There are shown a payer, a payee, and a payment provider, and messages exchanged between these parties. Preferably, the payer is a customer that has an account agreement with the payment provider. Based on this account agreement, the payer can withdraw from the payment provider payment certificates representing certain values. The payment certificates are valid for electronic payment transactions, for example, for the payment of goods or services.

The payment provider is either a single financial institution or a network of them. If the payment provider represents a network of financial institutions, different entities in the network can be defined. There can be access entities providing access to the network, withdrawal entities providing payment certificates to payers, authorization entities authorizing electronic payments, entities acquiring payments for payees, and central entities, that co-ordinate payment-related activities like authorizations, captures and clearings.

The payee can be a merchant who is paid for services or goods delivered to the payer. There can be various types of services that require different ways of paying. For example, in an e-commerce shop a payer performs by means of a macropayment transaction a one- time payment for possible many purchased items. In another example, a long-distance phone call must be paid, for example, by a micropayment transaction, simultaneously to many operators, wherein the total amount of the payment is not known until the call ends. The payee can have a merchant agreement with the payment provider, which provides the infrastructure needed to accept the payments.

During a withdrawal transaction 100, the payer gets from the payment provider blind signatures on anonymous certificates, so-called payment certificates. It is the meaning of a payment certificate that the payer, who proves the possession of a private key corresponding to a public key listed in the certificate, is authorized to spend the value specified in the certificate. During the withdrawal, the payment provider debits from the account of the payer the value of each withdrawn certificate.

A payment 110 shown in FIG. 1 can be performed by a macropayment or a micropayment. In a macropayment transaction, the payment certificates are treated as electronic coins representing a fixed maximum value. During an on-line macropayment, the payer transmits payment certificates to the payee. The payer proves the possession of the private keys corresponding to these payment certificates by means of responding to a challenge. The payee performs an on-line authorization 120 with the payment provider in order to check whether the payment certificates are valid.

In general, the payment provider stores these payment certificates from which values have been credited to any account. As soon as a payment certificate is stored at the payment provider, it is treated as already spent, i.e., as invalid, by the payment provider. In order to check whether a payment certificate is valid, i.e., in order to check against any double spending of the payment certificate, the payment provider searches his database for the certificate. If the certificate is found in the database, it has been credited already, and therefore, is invalid for any payment. Otherwise, it will be treated as valid, if it is authentic, and its value can be credited to the account of the merchant. At least, the merchant is informed during the on-line authorization whether the certificate is valid.

If the payment certificate is valid, the payee accepts the payment and delivers the ordered goods or services to the payer. If the value of the payment certificates presented to the payee is higher than the due amount to be actually paid, a change is returned to the payer. The change is transmitted in a message 130 from the payment provider to the payee, who forwards it in a message 140 to the payer.

In a micropayment transaction, also called as a series of micropayments, the private key corresponding to the payment certificate is treated as a means of signing an initial value in a one-way function chain. A generic scheme of a one-way function chain payment is as follows: The payer generates a chain wᵢ of one-way function values such that:

wᵢ=h(wᵢ₊₁)

h is a one-way function, for example, a hash function. The generation starts with wₙ and ends down at w₀. As the one-way function is irreversible, the chain cannot be calculated from w₀ up to wₙ. The payer signs the wo together with a commitment obligating himself to pay a certain amount, for example, a certain amount of money for each wi, and releases consecutive wᵢ (in ascending order) as payments. As h is an irreversible function, the payee cannot calculate the values, which are not yet released by the payer. Thus, the payee is unable to redeem more than he has been actually paid. The verification that the next wᵢ is actually the next value of the hash chain is performed by checking if its hash equals to the value of wᵢ₋₁. Because such a check can be performed down to w₀, which is signed by the payer, the payment can not be repudiated.

A micropayment transaction includes an on-line authorization that requires a communication connection between the payee and the payment provider, off-line micropayments, i.e., the single electronic micropayments are performed without any communication connection, an on-line final deposit and, if needed, an on-line change return. During the micropayment transaction, the payer presents a payment certificate to the payee. The payer proves the possession of the private key corresponding to the payment certificate and performs an on-line authorization with the payment provider to check against a double spending of the payment certificate. The payer signs the initial value of a one-way function chain (with the private key corresponding to the payment certificate) and presents it to the payee. The payer releases subsequent values of the one-way function chain as micropayment tokens. At the end of the micropayment series the payee presents the obtained one-way function chain to the payment provider and gets the amount credited to his account. If the value of the payment certificate has not been used up, change is given back to the payer.

In the following, the blind signature concept will be explained by means of an example based on the Rivest Shamir Adleman (RSA) signature scheme. RSA signatures are well known to a person skilled in the art. The example denotes a message m, for example, a change return certificate of the present invention, that a payer wants to be signed by a payment provider. The payment provider has, in accordance with the RSA scheme, a public exponent e, a private, i.e., secret, exponent d, and a value n for the calculation modulus n. The payer chooses a random number r, a so-called blinding factor, and prepares m_{b}, for example, the blinded change return certificate, which is to be signed by the payment provider, in the following way:

m_{b}=m*rₑ(mod n)

The payment provider signs m_{b} with his private key to obtain a blind signature s_{b}:

s_{b}=m_{b}^{d}=m^{d}*r^{e*d}=m^{d}*r(mod n)

The payer divides s_{b} by r (modulo n) and obtains

s=m^{d}

s=m^{d} is the signature on m. If m is a change return certificate, the payer is able to form a valid payment certificate k by linking the message m and the signature s:

k=m|s

If the payer keeps the blinding factor r secret, the payment provider cannot find out what he has signed. Therefore, the payment provider cannot trace any payment from knowing the blinded payment certificate. In order to prevent the payer from manipulating the value of the payment certificate the payment provider assigns different RSA key pairs for different values of payment certificates.

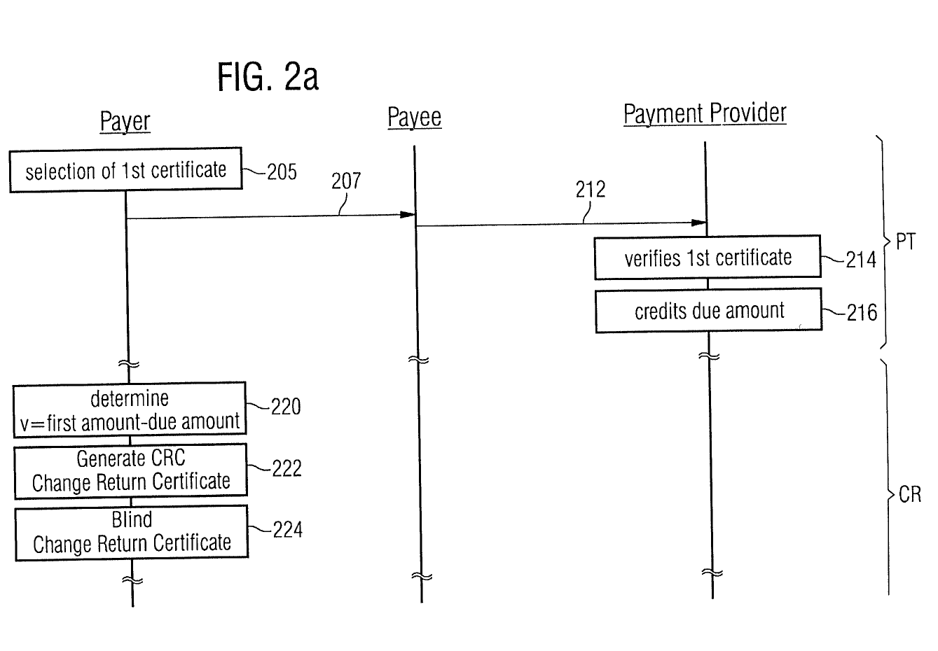

FIG. 2 shows a method of returning change to a payer in an electronic payment system. Preferably, a payment transaction phase (PT) precedes the returning of change. The payer possesses a valid first payment certificate having a value of a first amount. The first payment certificate can be a macropayment certificate or a micropayment certificate. In one embodiment, there is a first asymmetric key pair assigned by the payment provider to the first payment certificate. By means of the key pair, the payment provider can identify clearly the value, i.e., the first amount, of the certificate. The key pair comprises a first public key and a first private key, from which the public key is included in the first payment certificate.

The payer performs a selection 205 of the first payment certificate having a due amount that is lower than the first amount. Therefore, he can limit the value that will be credited from the payment provider on the presented first payment certificate, for example, by including the due amount in the first payment certificate. The first payment certificate is sent in a message 207 to the payee, who forwards the first payment certificate in a message 212 to the payment provider. The payment provider performs a verification 214 of the first payment certificate and checks the validity of the first payment certificate as described above by searching in a database. If the first certificate is valid, the payment provider credits the due amount to the payee. During a crediting 214, the payment provider stores the first payment certificate in his database (i.e., the first payment provider invalidates the first payment certificate for a further crediting of the due amount).

As the payer himself has paid during an earlier withdrawal transaction the first amount higher than the due amount, he requires change having a value of the difference of the first amount of the first payment certificate and the due amount. The corresponding change return transaction is shown in phase CR of FIG. 2.

The payer determines in step 220 at least one change return value such that the sum of the determined change return values is equal to the difference of the first amount and the due amount. Depending on the implementation of the payment system, payment certificates available might have certain discrete values. For example, if a payment system supports payment certificates having the values 0.1; 0.5; 1 and 5, and assuming a payer pays a due amount of 4.4 by a payment certificate having a first value of 5, the total change is 0.6, which cannot be paid back by a single certificate. In this case, the payer can choose between the change return value combination {0.5; 0.1} and {0.1; 0.1; 0.1; 0.1; 0.1; 0.1}. In both cases, the payer determines more than one change return value. If the due amount in the given example had been 4.9 , the payer would have determined just one change return value, i.e., 0.1.

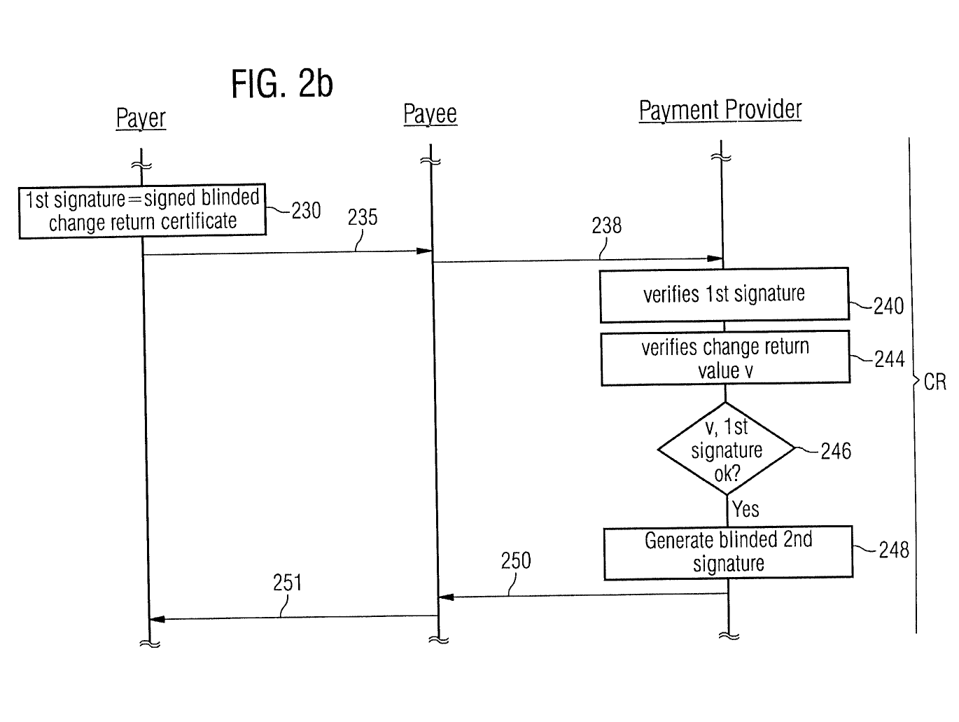

In step 222, the payer generates at least one change return certificate according to the determined change return value(s). An example of a change return certificate will be explained with respect to FIG. 3.

In step 224, the payer blinds the determined change return certificate, for example, by means of a blinding factor as described above. Preferably, the blinding factor is a random integer value, for example, generated by a random number generator. The payer keeps the blinding factor secret, but stores it for future use for verifications.

In an alternative embodiment, the payer builds a digest of the change return certificate and blinds the digest by means of the blinding factor. This can increase the security of the method and can facilitate lower complexity calculations, such as, for example, encryption and decryption. The digest can be built by means of a one-way function, for example, as a hash-value.

There is in a preferred embodiment a second asymmetric key pair comprising a second public key and a second private key assigned by the payment provider to the determined change return value. Then the blinding factor is decrypted by means of the second public key to allow for a validation of the change return certificate for its value.

In addition, the payment provider can send the second public key to the payee, who forwards it to the payer in order to ensure that the appropriate key is used for the blinding. This can be triggered, for example, by a corresponding request of the transmission by the payer or the payee.

There are several possibilities to indicate the value of the blinded change return certificate. An implicit indication is, if there exists in the whole payment system only one type of change return certificates, i.e., all change return certificate have the same value. In this case, no further information except about the existence of the change return certificate is needed to determine the value. In the alternative, the corresponding value might be derived by means of a unique correlation to the CRC from the change return certificate, by any pre-set deterministic scheme described by a bijection, or explicitly given by the payer. The value can be comprised in the change return certificate or linked to it, for example, by means of a signature of step 230, or it can be comprised in a message 235, 238.

In step 230, the payer generates a first signature by signing the blinded change return certificate. The first signature indicates the first payment certificate, on which the change return is based, or at least its value. This is achieved, for example, if the first signature is generated by the payer by means of the first private key, while the first key pair is assigned by the payment provider to the value of the first payment certificate.

In step 235, a message comprising the first signature is sent from the payer to the payee, who forwards the message 238 to the payment provider. This indirect transmission ensures the anonymity of the payer with respect to the payment provider. The message can comprise, apart from the first signature, for example, the blinded change return certificate or its assigned value, for example, for the purpose of verification.

The payment provider verifies the first signature in step 240 in order to determine whether the first signature, which is treated as a request for change return, relates to the first payment certificate on which the change return transaction is based. The verification can be done by decrypting the first signature by means of the first public key. Furthermore, the payment provider checks by searching its database, as described before, to determine whether the first payment certificate is valid for a payment.

In addition, the payment provider verifies whether the change return value, which is requested and indicated implicitly or explicitly by the received message comprising the first signature, is correct. For example, if the sum of the requested change return value and the due amount credited to the payee is higher than the value of the first amount of the first payment certificate, the payment provider rejects the returning of change.

If both verifications are successfully performed in step 246, the payment provider generates a blinded second signature by signing the blinded change return certificate from the received message. This can be done, for example, by signing the blinded change return certificate by means of the second secret key.

The payment provider forwards the blinded second signature to the payer, preferably via the payee in messages 250, 251. In the alternative, the forwarding can be performed via any other trusted third party. As long as the payment provider cannot forward the blinded second signature directly to the payer, the anonymity of the change return transaction is secured.

In one embodiment of the invention, the payment provider stores at least one from either the first signature and the message comprising the first signature. This is useful if the payer claims that the requested change has not been returned. For this purpose, the payer can connect to the payment provider, prove the possession of the first private key corresponding to the first payment certificate, and request the change. Now the payment provider can check his database for the status of the transaction involved. If the payment provider has already issued the change for the respective transaction, the payer is either trying to manipulate or the protocol of returning the change has failed, for example, because the forwarded blinded second signature has been lost on the transmission path. In both cases the payment provider can re-send the blinded second signature he has already signed to the payer. Even if the payer claims the change many times, he always receives the same second blinded signature. Thus, he gains nothing but the rightful change, which can be spent only once.

In step 260, the payer unblinds the received blinded second signature, for example, by a division of the blinded second signature by the blinding factor. The payer verifies the unblinded second signature in step 270, for example, by a decryption of the unblinded second signature and a test of whether the decrypted unblinded second signature corresponds to a generated change return certificate. If the verification is successful (step 280), the payer generates in step 290 a second payment certificate, which comprises the change return certificate linked to the unblinded second signature.

Preferably, the payer stores the second payment certificate. In the alternative, he can use the certificate directly for another payment transaction. In one embodiment of the invention, the payer sends the certificate and/or a private key corresponding to the certificate to a trusted third party for storing as a backup. This is useful in case the payment device storing the second payment certificate is stolen, lost, or due to other reasons out of order. The backup ensures in these cases that the second payment certificate is not permanently lost.

In the following, a preferred embodiment is summarized as a change protocol specification. The first two messages of the change return protocol are in a preferred embodiment of the invention piggybacked with the payment messages 110, 120 either corresponding to macropayment or micropayment protocols. During the change return protocol, usually more than one payment certificate needs to be signed by the payment provider in order to express the value of the change needed. The specification below presents the protocol for a plurality of certificates. They are numbered from 1 to n. However, after unblinding, all the payment certificates issued as change are independent of each other. It is assumed that the change is given back from a first payment certificate, whereto a public and private key respectively PC₀, SC₀ are assigned. The signature scheme used to sign the certificates is RSA.

A payment certificate can be for example a Simple Public Key Infrastructure (SPKI) certificate, which is a credential certificate that directly binds a key to an authorization. As the name of the certified entity is not involved, any authorization can be proved anonymously. The main goal of a SPKI certificate is to transfer authorization without using the name of the keyholder. An authorization SPKI certificate can contain the following fields: the issuer of the certificate; the subject (e.g., the public key); a delegation; (i.e., a flag stating whether the subject can transfer the authorization to some other entities); an authorization; and a validity period. The delegation flag is preferably set for payment certificates to the value ‘false’.

A typical application of an SPKI certificate is as follows: an entity A presents his SPKI authorization certificate and proves that he possesses the private key corresponding to the public key on the certificate. By such verification, along with verification whether the issuer of this certificate was authorized to issue it, one can be convinced that A is actually authorized to the resources of interest. The name of A was not involved, so he can stay anonymous.

The following table explains the symbols used in the specification.

| | |
|---|---|
| =?= | Comparison of two expression |
| = | Assignment |
| \| | Concatenation |
| {x}S | Signature on message x performed with key S |
| C, C_{$v} | Payment certificate, payment certificate worth v |
| C_{b} | Blinded payment certificate |
| C_{raw} | Unsigned certificate |
| D_{$v,t} | Private RSA exponent in key SB_{$v,t} |
| E_{$v,t} | Public RSA exponent in key PB_{$v,t} |
| H(x) | Message digest of x |
| N_{$v,t} | RSA modulus in key PB_{$v,t} |
| PB_{$v,t,} | Respectively public and private RSA key used by the |
| | payment provider to sign the |
| SB_{$v,t} | payment certificates of value v at time t. |
| PC₀, SC₀ | Respectively public and private key of the payment |
| | certificate from which the change is being returned. |
| R | Symbol denoting blinding factor |
| S_{b} | Payment provider’s blind signature on the payment certificate. |
| SPKI (PC, | Transformation that outputs unsigned SPKI certificate |
| v, t) | containing PC as subject, |
| | authorization for spending value of v, and validity starting |
| | from time t |
| Sᵤ | Payment provider’s signature on the payment certificate- |
| | unblinded by the payer. |
| T | Symbol denoting time |
| V | Symbol denoting value |

In a first step, the payer generates random asymmetric key pairs:

(PC₁, SC₁), . . . , (PCn, SCn).

In the next step, the payer generates new SPKI certificates with a total value of the change to be given back:

Craw₁=SPKI(PC₁, v₁, t); . . . ; Crawn=SPKI(PCn, vn, t)

In the next step, the payer generates blinding factors r1, . . . , rₙ for these certificates. Optionally, the payment provider sends the payee the current public keys PB_{$*, t} used to sign the payment certificates. Optionally, the payee forwards to the payer the current public keys PB_{$*, t} used to sign the payment certificates.

Then, the payer prepares blinded message digests of the change payment certificates:

C_{b1}=H(Craw₁)*r^{E$v1t}(mod n_{$v1,t})

. . .

C_{bn}=H(Craw₁)*r^{E$vn,t}(mod n_{$vn,t})

The payer sends these blinded message digests, along with the certificate requested by the payer and a signature performed with the private key of the payment certificate from which the change is returned. These blinded message digests can be treated as blinded payment certificates:

C_{b1}, v₁, . . . , C_{bn}, vₙ, {C_{b1}, v₁, . . . , C_{bn}, vₙ}SC₀

The payee forwards this message to the payment provider.

The payment provider verifies the signature and stores the whole message in his database. Thus it is possible to reissue this change afterwards. It is also checked if the total value of all these certificates is complementary with the value of the underlying transaction. The following is verified and stored:

C_{b1}, v₁, . . . , C_{bn}, vₙ, {C_{b1}, v₁, . . . , C_{bn}, vₙ}SC₀

The payment provider blindly signs the message digests of the payment certificates with appropriate keys:

S_{b1}=C_{b1d$v1,t}(mod n_{$v1,t})

. . .

S_{bn}=C_{bnd$vn,t}(mod n_{$vn,t})

These signatures S_{b1}, . . . , S_{bn} are sent to the payee. The payee forwards the signatures S_{b1}, . . . , S_{bn} to the payer.

The payer unblinds the signatures:

Sᵤ₁=S_{b1}/r₁(mod n_{$v1,t})={Craw₁}SB_{$v1,t}

. . .

Sᵤₙ=S_{bn}/rₙ(mod n_{$vn,t})={C_{rawn}}SB_{$vn,t}

The payer verifies the signatures:

Sᵤ₁^{e$v1,t}(mod n_{$v1,t})=?=H(C_{raw1})

. . .

Sᵤₙ^{e$vn,t}(mod n_{$vn,t})=?=H(C_{rawn})

The payer forms signed payment certificates:

C₁=C_{raw1}|Sᵤ₁

. . .

Cₙ=C_{rawn}|Sᵤₙ

In a further preferred embodiment, the present invention is realized by a computer program, which performs the steps of the inventive method if it is executed on a digital processing device. Such a computer program can be used, for example, for the purpose of a simulation of a change return transaction of an electronic payment system or for a presentation due to product marketing reasons.

The returning of change is described in the above embodiments from a system point of view. Further embodiments of the invention relate to implementations of those parts of the method that are performed by the different involved parties. In particular, a useful embodiment represents a method of performing tasks of a payer in a change returning transaction in an electronic payment system. The method comprises the mentioned steps above, in which the payer is involved. A preferred embodiment relates to a computer program that performs these steps, as it allows for an easy implementation of the payer's part of the method in a payer's terminal, also called payment device, for example, by means of the implementation in a corresponding protocol stack.

A further useful embodiment represents a method of performing tasks of a payment provider in a change returning transaction in an electronic payment system. The method comprises the mentioned steps, in which the payment provider is involved. A preferred embodiment relates to a computer program that performs these steps, as it allows for an easy implementation of the payment provider's part of the method in a corresponding terminal or subsystem like a bank device, for example, by means of the implementation in a corresponding protocol stack.

Further embodiments relate to the computer programs stored each on a computer readable medium. A computer readable medium can be a floppy disk, a hard disk, an optical disc, a CD-ROM, a memory chip, or a secure memory chip. These allow for a portability of the computer programs. In particular, in the case of a secure memory chip, security against unauthorized manipulations by third parties is provided.

FIG. 3 shows an example of a payment certificate. The payment certificate comprises a public key (PC), a value v and a time t representing a validity of the certificate.

The validity time t can in dependence on the implementation of the change return protocol be a duration for which the certificate is valid, a time when the certificate has been issued (e.g., if the payment system operates with default validity periods), or a time when the certificate becomes invalid.

The values of payment certificates are preferably discrete and selected from a sequence of the form of 0.01; 0.02; 0.05; 0.1; 0.2; 0.5; 1; 2; 5; 10; 20; 50 . . . . The average number of certificates needed to express an arbitrary amount equals C*n/ln(n), where n is the base of the notation system (n=2 for binary system, n=10 for decimal system) and C is a constant. Thus the optimal n equals 2.71, which means that the smallest number of payment certificates needed is obtained for n=2 or n=3. As the 1, 2, 5 system is used in most of the cash systems and is quite close to binary system (1, 2, 4), it satisfies both efficiency and human intuition.

The only mandatory field in a payment certificate, which is used in key-based, for example, RSA-based, electronic payment system, is the public key (PC). However other information, such as the issuer, the value, and the validity can be explicitly defined. The payment certificate can be valid only in conformance to the information implicitly expressed by the payment provider's choice of the signing key. Neither the name of the payer nor information that could identify the payer has to be listed on the payment certificate. Furthermore, any two payment certificates can be independent of each other. These properties, along with the use of blind signatures, ensure the anonymity of the payer as well as untraceability and unlinkability of his transactions.

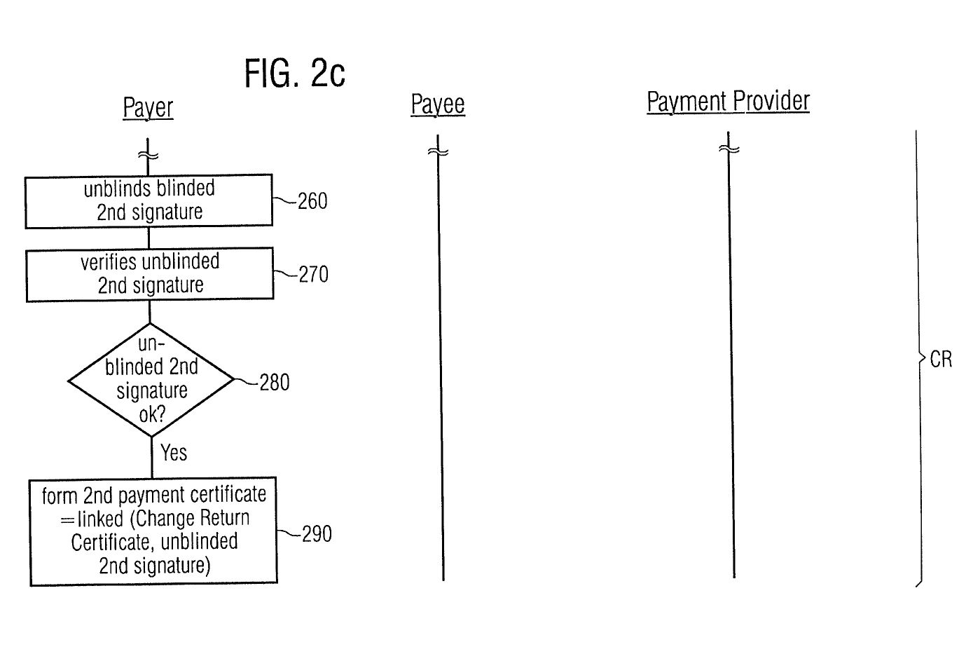

FIG. 4 shows a payment device (PD) (e.g., a mobile phone), comprising a crypto-processor (CP) that is a processor capable of performing, in particular, complex mathematical calculations such as encryption and decryption operations in an effective manner, a secure memory (SM) (i.e., a tamper resistant device, for storing, for example, private keys), a further memory (M), for example, for storing public keys (PC) and payment certificates, a random number generator (RN), for example, for generation of random numbers needed for generation of keys or blinding factors, and an Input-Output Interface (IO) for information transmission purposes. The crypto-processor is connected to the secure memory, the memory, the random number generator and the Input-Output Interface. The payment device is adapted to perform the tasks of a payer in a change returning transaction in an electronic payment system according to any method described above. Therefore, a corresponding computer program according to the invention can be used, which can be loaded for example, in the secure memory and executed by the crypto-processor.

Another embodiment of the present invention relates to a chip card, which comprises at least one element from the group of crypto-processor, secure memory, memory, and random number generator, wherein the chip card can be inserted into a complementary payment device, for example, a mobile phone or a laptop computer, resulting in the payment device as shown in FIG. 4. The complementary payment device with the inserted chip card is adapted to perform the tasks of a payer in a change returning transaction in an electronic payment system according to any method described above. In a further embodiment, the chip card is a Subscriber Identity Module SIM card for a mobile phone.

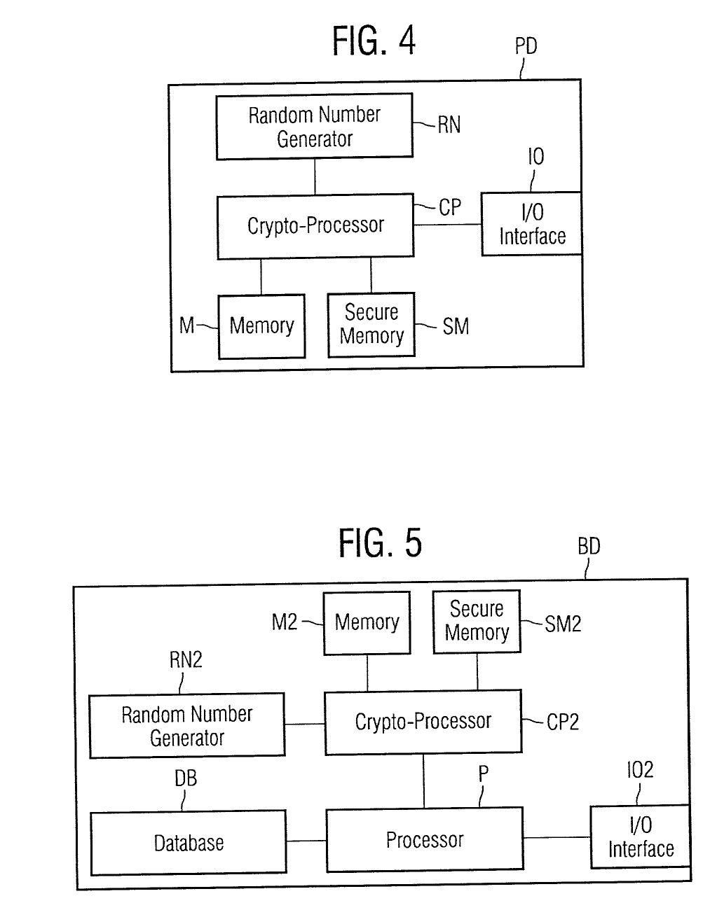

FIG. 5 shows a bank device (BD) comprising a processor (P), a crypto-processor (CP2) that is a processor capable of performing, in particular, complex mathematical calculations like encryption and decryption operations in an effective manner, a secure memory (SM2) for storing, for example, private keys and payment certificates, a memory (M2), for example, for storing public keys (PC), a random number generator, for example, for generation of random numbers needed for generation of keys or blinding factors, a database (DB) for storing payment certificates of which value has been credited to a payee, and an Input-Output Interface (IO2) for information transmission purposes. The crypto-processor is connected to the secure memory, the memory, and the random number generator. The processor is connected to the crypto-processor, the database, and the Input-Output Interface. The bank device is adapted to perform the tasks of a payment provider in a change returning transaction in an electronic payment system according to the method described above. Therefore, a corresponding computer program according to the invention can be used, which can be loaded, for example, in the secure memory.

What is claimed is:

1. A method of returning change to a payer in an electronic payment system wherein a due amount is paid by a payer to a payee via a first payment certificate having a value of a first amount higher than a due amount, the method comprising:
receiving, by a payment provider, of the first payment certificate;
verifying, by the payment provider, of the first payment certificate;
crediting, by the payment provider, of the due amount to the payee;
determining, by the payer, of at least one change return value such that the sum of the determined at least one change return value is equal to a difference between the first amount and the due amount;
generating, by the payer, of at least one change return certificate according to the at least one change return value;
blinding, by the payer, of the change return certificate;
generating, by the payer, of a first signature by signing the blinded change return certificate;
sending, by the payer, of a message comprising the first signature to the payee;
forwarding, by the payer, of the message to the payment provider;
verifying, by the payment provider, of the first signature;
verifying, by the payment provider, of a change return value indicated by the message;
generating, by the payment provider, of a blinded second signature by signing the blinded change return certificate if the verification of the first signature and of the change return value is successful;
forwarding, by the payment provider, of the blinded second signature to the payer;
unblinding, by the payer, of the blinded second signature;
verifying, by the payer, of the second signature;
forming, by the payer, of at least one second payment certificate by linking the change return certificate and the unblinded second signature.

2. The method of claim 1, further comprising:
assigning, by the payment provider, of a second asymmetric key pair comprising a second public key and a second private key to a change return value;
blinding, by the payer, of the change return certificate via a blinding factor, the blinding factor being encrypted via the second public key;
generating, by the payment provider, of the blinded second signature by signing the blinded change return certificate via the second secret key;
wherein the step of unblinding of the blinded second signature by the payer comprises a division of the blinded second signature by the blinding factor;
wherein the step of verifying the second signature by the payer comprises a decryption of the unblinded second signature and a test of whether the decrypted unblinded second signature corresponds to a generated change return certificate.

3. The method of claim 1, wherein the payment provider sends the second public key to the payee and the payee forwards the second public key to the payer.

4. A method of performing tasks of a payment provider in a change returning transaction in an electronic payment system, wherein a payment provider receives a first payment certificate having a value of a first amount higher than the due amount and verifies the first payment certificate and credits the due amount to a payee, the method comprising:
receiving a message comprising a first signature of a blinded change return certificate;
verifying the first signature;
verifying a change return value indicated by the message;
generating a blinded second signature by signing the blinded change return certificate if the verification of the first signature and of the change return value is successful; and
sending the second signature to the payee.

5. The method of claim 4, wherein:
a second asymmetric key pair comprising a second public key and a second private key is assigned by the payment provider to the change return value;
the change return certificate is blinded by means of a blinding factor encrypted via the second public key; and
the blinded second signature is generated by the payment provider by signing the blinded change return certificate by means of the second secret key.

6. The method of claim 4, wherein the message comprising the first signature includes the first payment certificate in order to perform crediting of the first amount.

7. The method of claim 4, wherein:
a first asymmetric key pair comprising a first public key and a first private key is assigned to the first payment certificate;
the first payment certificate comprises the first public key;
the first signature is generated by the payer via the first private key; and
the verification of the first signature is performed by the payment provider via the first public key.

8. The method of claim 4, wherein:
the first signature indicates the value of the first amount of the first payment certificate; and
the payment provider verifies the value of the first amount of the first payment certificate.

9. The method of claim 4, wherein the payment provider stores at least one of the first signature and the message comprising the first signature.

10. A method of performing tasks of a payer in a change returning transaction in an electronic payment system wherein the payer pays a due amount by means of a first payment certificate having a value of a first amount higher than the due amount, the method comprising:
determining at least one change return value such that the sum of the determined change return values is equal to a difference of the first amount and the due amount;
generating at least one change return certificate according to the at least one change return value;
blinding the change return certificate;
generating a first signature by signing the blinded change return certificate;
sending a message comprising the first signature to a payee;
receiving a blinded second signature comprising a signed blinded change return certificate;
unblinding the blinded second signature;
verifying the second signature; and
forming at least one second payment certificate by linking the change return certificate and the unblinded second signature.

11. The method of claim 10, wherein:
a first asymmetric key pair comprising a first public key and a first private key is assigned to the first payment certificate;
the first payment certificate comprises the first public key;
the first signature is generated by means of the first private key.

12. The method of claim 10, wherein
a second asymmetric key pair comprising a second public key and a second private key is assigned to a change return value;
the change return certificate is blinded by means of a blinding factor encrypted by means of the second public key;
the unblinding of the blinded second signature comprises a division of the second signature by the blinding factor;
the verification of the second signature comprises the decryption of the unblinded second signature and a test of whether the decrypted unblinded second signature corresponds to a generated change return certificate.

13. The method of claim 10, wherein the first signature indicates the value of the first amount of the first payment certificate.

14. The method of claim 10, further comprising receiving the second public key.

15. The method of claim 10, wherein at least one of the second payment certificate and a private key corresponding to the second payment certificate is sent to a third party for storing as a backup.

16. The method of claim 10, wherein the first signature is generated by signing the blinded change return certificate and a change return value linked to the blinded change return certificate.

17. The method of claim 10, wherein the message comprises at least one of the blinded change return certificate and the change return value corresponding to the blinded change return certificate.

18. The method of claim 10, wherein the first payment certificate comprises a macropayment certificate.

19. The method of claim 10, wherein the first payment certificate comprises a micropayment certificate.

20. The method of claim 10, wherein the blinding of the change return certificate comprises building a digest of the change return certificate and blinding the digest.

21. The method of claim 10, wherein the message comprising the first signature includes the first payment certificate in order to perform the payment of the first amount.

22. An article of manufacture for returning change to a payer in an electronic payment system, wherein a due amount is paid by a payer to a payee via a first payment certificate having a value of a first amount higher than a due amount, the article of manufacture comprising:
at least one computer readable medium;
processor instructions contained on the at least one computer readable medium, the processor instructions configured to be readable from the at least one computer readable medium by at least one processor and thereby cause the at least one processor to operate as to:
receive the first payment certificate;
verify the first payment certificate; and
credit the due amount to the payee;
wherein the payer determines at least one change return value such that the sum of the determined at least one change return value is equal to a difference between the first amount and the due amount;
wherein the payer generates at least one change return certificate according to the at least one change return value;
wherein the payer blinds the change return certificate, wherein the payer generates a first signature by signing the blinded change return certificate;
wherein the payer sends a message comprising the first signature to the payee;
wherein the payer forwards the message to the payment provider;
the processor instructions being further configured to be readable from the at least one computer readable medium by the at least one processor and thereby cause the at least one processor to operate as to:
verify the first signature;
verify a change return value indicated by the message;
generate a blinded second signature by signing the blinded change return certificate if the verification of the first signature and of the change return value is successful; and
forward the blinded second signature to the payer;
wherein the payer unblinds the blinded second signature;
wherein the payer verifies the second signature; and
wherein the payer forms at least one second payment certificate by linking the change return certificate and the unblinded second signature.

23. A payment device comprising:
means for determining at least one change return value such that the sum of the determined at least one change return value is equal to a difference of a first amount and a due amount;
means for generating at least one change return certificate according to the at least one change return value;
means for blinding the change return certificate;
means for generating a first signature by signing the blinded change return certificate;
means for sending a message comprising the first signature to a payee;
means for unblinding a blinded second signature comprising a signed blinded change return certificate;
means for verifying the second signature; and
means for forming at least one second payment certificate by linking the change return certificate and the unblinded second signature.

24. The payment device of claim 23, wherein the payment device comprises a mobile phone.

25. A bank device adapted to perform tasks of a payment provider in a change returning transaction in an electronic payment system, the bank device comprising:
means for receiving a message comprising a first signature of a blinded change return certificate;
means for verifying the first signature;
means for verifying a change return value indicated by the message;
means for generating a blinded second signature by signing the blinded change return certificate if the verification of the first signature and of the change return value is successful; and
means for sending the second signature to the payee.
